(19) United States
(12) Patent Application Publication
(10) Pub. No.: US 2026/0122697 A1
(43) Pub. Date: Apr. 30, 2026

(54) Processing Device, Processing System, Repeater, Processing Program, And Processing Method

(71) Applicant: Bitkey Inc., Chuo-ku, Tokyo (JP)

(72) Inventors: Ryo SASAKI, Tokyo (JP); Keizo FURUKAWA, Tokyo (JP)

(21) Appl. No.: 19/227,607

(22) Filed: Jun. 4, 2025

Related U.S. Application Data
(63) Continuation of application No. PCT/JP2023/038992, filed on Oct. 27, 2023.

(30) Foreign Application Priority Data
Dec. 9, 2022 (JP) 2022-197300

(51) Int. Cl. H04W 76/10; H04L 9/06

(52) U.S. Cl. CPC H04W 76/10; H04L 9/0631

(57) ABSTRACT

Provided is a processing device capable of remotely, safely, and accurately controlling operations of various electric installations provided in each facility. The processing device includes at least one processor. The at least one processor is configured to execute a computer readable instructions so as to: generate first information according to a type of an electric installation installed in a different facility, processing the first information in accordance with a control panel of the electric installation to generate second information, establish secret communication connection with at least one repeater installed in the different facility, and transmitting the second information to the control panel via the repeater in a secret state.

### CROSS-REFERENCE TO RELATED APPLICATIONS

The present application is a continuation application of International Application No. PCT/JP2023/038992, filed on Oct. 27, 2023, which is expressly incorporated herein by reference in its entirety.

### BACKGROUND

### Technical Field

The present disclosure relates to a processing device, a processing system, a processing program, a processing method, and a repeater connected to the processing device that remotely control an operation of an electric installation provided in each facility.

### Related Art

Conventionally, it has been known that image information around an elevator, which is a type of electric installation provided in a building, is transmitted to an external information device, and the elevator is monitored using an Internet line. For example, Patent Literature 1 (JP 2020-29321 A) describes “an elevator including: a car that moves up and down in a hoistway; an upper camera that is installed on an upper side of the car and is capable of capturing an image of a region above the car; a lower camera that is installed on a lower side of the car and is capable of capturing an image of a region below the car; and a transmission unit that is capable of externally transmitting an upper image signal including upper image information based on an upper image captured by the upper camera and a lower image signal including lower image information based on a lower image captured by the lower camera”.

However, in the elevator described in Patent Literature 1, transmission and reception of image signals and partial control of the elevator can be performed remotely, but a setting change or the like cannot be performed remotely for accompanying installations such as a camera. In addition, a network of Patent Literature 1 is vulnerable to security, and signals that can be handled as remote control are limited.

### SUMMARY

The present disclosure has been made from the background described above, and relates to a processing device, a processing system, a repeater, a processing program, and a processing method capable of remotely, safely, and accurately controlling operations of various electric installations provided in each facility.

According to one aspect of the present disclosure, there is provided “a processing device comprising: at least one processor, wherein the at least one processor is configured to execute a computer readable instructions so as to: generate first information according to a type of an electric installation installed in a different facility, processing the first information in accordance with a control panel of the electric installation to generate second information, establish secret communication connection with at least one repeater installed in the different facility, and transmitting the second information to the control panel via the repeater in a secret state”.

According to one aspect of the present disclosure, there is provided “a processing system that includes a processing device including at least one processor, the at least one processor being configured to execute a computer readable instructions so as to generate first information according to a type of an electric installation installed in a different facility, process the first information in accordance with a control panel of the electric installation to generate second information, establish secret communication connection with at least one repeater installed in the different facility, and transmit the second information to the control panel via the repeater in a secret state, the repeater establishing the secret communication connection with the processing device, and the control panel communicably connected to the repeater, wherein the control panel generates third information for supporting and controlling the electric installation, and transmits the third information to the electric installation”.

According to one aspect of the present disclosure, there is provided “a repeater that establishes secret communication connection with a processing device including at least one processor, the at least one processor being configured to execute a computer readable instructions so as to generate first information according to a type of an electric installation installed in a different facility, process the first information in accordance with a control panel of the electric installation to generate second information, establish secret communication connection with at least one repeater installed in the different facility, and transmit the second information to the control panel via the repeater in a secret state, wherein the repeater includes at least one processor, and the at least one processor is configured to execute a computer readable instructions so as to establish the secret communication connection with the processing device installed in the different facility and receiving the second information as secret information”.

According to one aspect of the present disclosure, there is provided “a computer program product embodying computer readable instructions stored on a non-transitory computer-readable storage medium for causing a computer to execute a process by at least one processor so as to perform the steps of: generating first information according to a type of an electric installation installed in a different facility; processing the first information in accordance with a control panel of the electric installation to generate second information; establishing secret communication connection with at least one repeater installed in the different facility; and transmitting the second information to the control panel via the repeater in a secret state”.

According to one aspect of the present disclosure, there is provided “a method for causing a processor to execute a process, the method comprising executing on a processor in a computer the steps of: generating first information according to a type of an electric installation installed in a different facility; processing the first information in accordance with a control panel of the electric installation to generate second information; establishing secret communication connection with at least one repeater installed in the different facility; and transmitting the second information to the control panel via the repeater in a secret state”.

According to the present disclosure, it is possible to provide a processing device, a processing system, a repeater, a processing program, and a processing method capable of remotely, safely, and accurately controlling operations of various electric installations provided in each facility.

Note that the above effects are merely exemplary for convenience of description, and are not restrictive. In addition to or instead of the above effects, any effect described in the present disclosure or an effect obvious to those skilled in the art can be achieved.

### BRIEF DESCRIPTION OF THE DRAWINGS

FIG. 1 is a diagram illustrating a schematic configuration of a processing system 1 according to a first embodiment of the present disclosure.

FIG. 2 is a block diagram illustrating an example of a configuration of a communication device 100 according to the first embodiment of the present disclosure.

FIG. 3 is a block diagram illustrating an example of a configuration of a repeater 200 according to the first embodiment of the present disclosure.

FIG. 4 is a block diagram illustrating an example of a configuration of a control panel 300 according to the first embodiment of the present disclosure.

FIG. 5 is a block diagram illustrating an example of a configuration of a server device 500 according to the first embodiment of the present disclosure.

FIG. 6 is a diagram illustrating a processing sequence executed among the communication device 100, the repeater 200, the control panel 300, and the server device 500 according to the first embodiment of the present disclosure.

FIG. 7 is a diagram illustrating a processing sequence executed among the communication device 100, the repeater 200, the control panel 300, and the server device 500 according to the first embodiment of the present disclosure.

FIG. 8 is a diagram illustrating a processing sequence executed among the communication device 100, the repeater 200, a control panel 300a1, a control panel 300a2, and the server device 500 according to the first embodiment of the present disclosure.

FIG. 9 is a diagram illustrating a processing sequence in a comparative example.

FIG. 10 is a diagram illustrating a schematic configuration of an application example of the processing system 1 according to the first embodiment of the present disclosure.

FIG. 11 is a diagram illustrating a schematic configuration of a comparative example.

FIG. 12 is a diagram illustrating a schematic configuration of a processing system 1 according to a second embodiment of the present disclosure.

### DETAILED DESCRIPTION

Hereinafter, as an example of an embodiment of the present invention, each embodiment will be described with reference to the accompanying drawings by taking a case where the present invention is applied to a vehicle usage management system as an example. Common components in the drawings are denoted by the same reference numerals.

### First Embodiment

### 1. Outline and Configuration of Processing System 1 According to Present Disclosure

As an example, the processing system 1 according to the present disclosure is used to control an electric installation installed in each facility from a remote place, or to obtain information regarding the electric installation even at the remote place. For example, the processing system is suitably used for an elevator installed in a building or the like in a case where the elevator is controlled from the outside of the building in a state where security is ensured. Furthermore, the processing system can be suitably used in a case where information obtained from a sensor installed in an observation facility is obtained and confirmed even outside the observation facility in a state where security is ensured. Specifically, in such a case, the processing system 1 achieves secure and reliable transmission and reception of information by establishing communication connection between each facility and the outside of the facility as secret communication connection having high security.

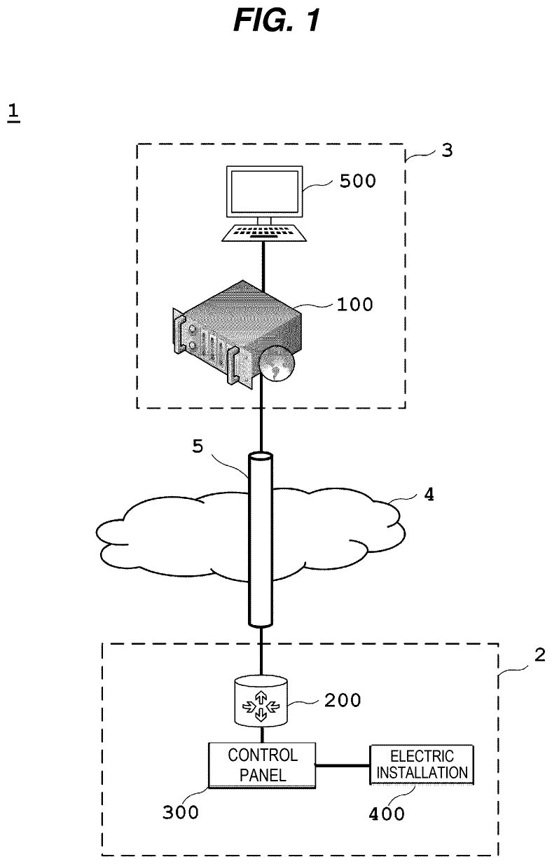

FIG. 1 is a diagram illustrating a schematic configuration of a processing system 1 according to a first embodiment of the present disclosure. Specifically, FIG. 1 illustrates a connection relationship for data transmission in a facility 2 and a cloud system (processing device) 3 provided on a cloud different from the facility 2. More specifically, in the processing system 1, the facility 2 is communicably connected to a communication device 100 of the cloud system 3 via the Internet 4.

As illustrated in FIG. 1, a repeater 200, a control panel 300, and an electric installation 400 are installed in the facility 2. These devices are communicably connected by a wired or wireless internal network of the facility 2. In addition, the repeater 200 functions as a window for data communication of the facility 2 and enables transmission and reception of data to and from the outside of the facility 2 via the Internet 4. In the first embodiment, in particular, the VPN connection 5 can be established as an example of the secret communication connection between the communication device 100 and the repeater 200.

Further, as illustrated in FIG. 1, the cloud system 3 includes a communication device 100 for communication connection with the repeater 200 and a server device 500 for managing the electric installation 400 of the facility 2. The communication device 100 and the server device 500 are connected so as to be able to transmit and receive information in the cloud system 3. Here, since the communication device 100 and the server device 500 exist in the same cloud system, the secret communication connection is enabled using a secure socket layer (SSL) different from the VPN connection 5.

With the configuration illustrated in FIG. 1, in the processing system 1, it is possible to manage, for example, control and monitor the electric installation 400 in the facility 2 remotely from the server device 500. Here, instead of directly accessing the facility 2 from the server device 500, the management is performed by data transmission and reception via the communication device 100. However, since transmission and reception of information between the communication device 100 and the server device 500 are processing in the cloud system 3, transmission and reception of information to and from the repeater 200 are processing in the server device 500. Between the communication device 100 and the repeater 200, a secret state of various types of information to be transmitted and received is secured by the VPN connection 5. That is, remotely managing the electric installation 400 in the facility 2 from the server device 500 ensures security and is performed safely and reliably.

Here, the facility 2 is not limited to the building described above, and may include various structures and mobile objects provided on the land, the sea, and the sky. For example, as the facility 2 of the structure, a building, an observation platform on a mountain (mountainous facility), a plant (marine facility) in the sea or on the sea, a work facility in a mine, a dam, or the like, a monitoring facility in a power plant, a substation, or the like, and a satellite in space correspond as an example. In addition, a passenger car, a truck, a ship, and an aircraft correspond to the facility 2 of the mobile object as an example.

The electric installation 400 is not limited to the elevator described above, and may include a general device that is driven or operated using electricity provided in the facility 2. Here, even a device driven by fuel or the like other than electricity is naturally included in the electric installation 400 when an auxiliary operation by electricity (data display, data communication, or the like) is executed. For example, when the facility 2 is a building, an elevator, an escalator, an entrance/exit management device, an air conditioning installation, a lighting installation, and an acoustic installation correspond thereto as an example. In a case where the facility 2 is the mobile object or satellite described above, a drive source, a sensor, a lighting fixture, an acoustic fixture, an air conditioner, and the like correspond thereto as an example. Further, in a case where the facility 2 is the mountainous facility, the marine facility, the work facility, or the monitoring facility described above, various sensors, various installation maintenance devices, and the like correspond thereto as an example.

As described above, the management target in the processing system 1 according to the first embodiment of the present disclosure is a management target for which direct access to the site is difficult (installation in a mountainous or marine facility), a management target for which the importance of management is very high while access is difficult (sensor installation in a mine or a dam), a management target for which unmanned maintenance or inspection is required (mobile object capable of automatic operation), and a management target for which improvement in operation efficiency is expected by labor saving operation or control (various installations such as buildings). That is, the processing system 1 can be widely used.

By utilizing the processing system 1 in the facility 2 as described above, an end user who uses the facility 2 can achieve automation of maintenance by getting out of artificial actions, and thus, downtime of the facility 2 and the electric installation 400 is reduced, and the facility 2 can be continuously used. In addition, for a person who performs maintenance or operation of the facility 2, maintenance or operation work can be simplified, continuity of maintenance or operation can be easily improved, and maintenance and operation costs of the facility 2 can be reduced.

Although the number of each of the facility 2, the repeater 200, the control panel 300, and the electric installation 400 in FIG. 1 is one, a plurality of facilities 2, a plurality of repeaters 200, a plurality of control panels 300, and a plurality of electric installations 400 may be provided. For a case where the number of each device is plural, an example thereof will be described later in an application example or another embodiment.

### 2. Configuration of Communication Device 100

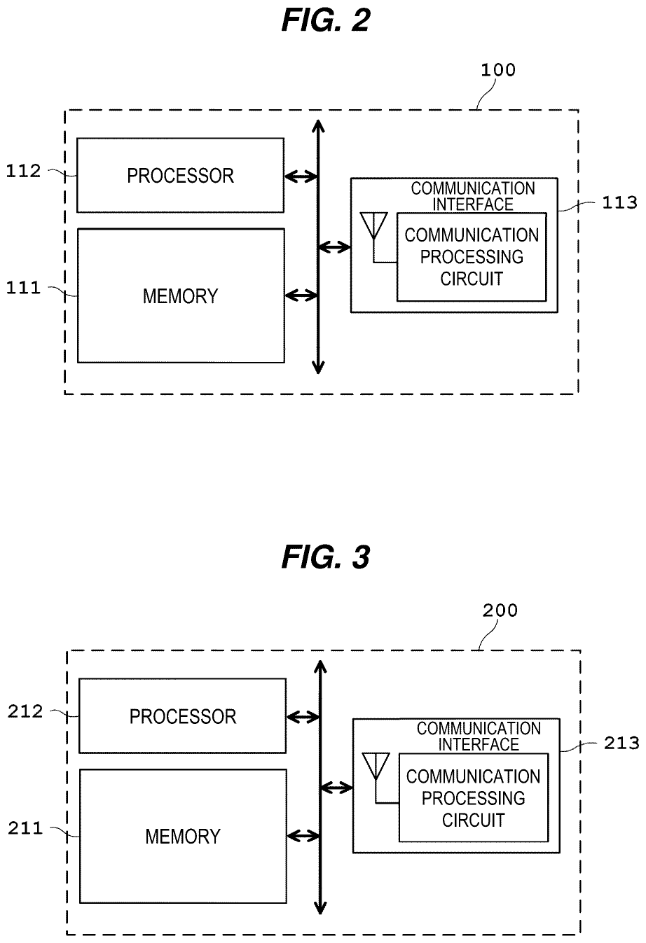

FIG. 2 is a block diagram illustrating an example of a configuration of the communication device 100 according to the first embodiment of the present disclosure. The communication device 100 does not need to include all components illustrated in FIG. 2, and may have a configuration in which a part is omitted, or may include other components. Further, the communication device 100 does not need to include those illustrated in FIG. 2 in a single casing, and each component and processing of the communication device 100 can be distributed to a plurality of server devices and communication devices.

According to FIG. 2, the communication device 100 includes a memory 111 including a RAM, a ROM, a nonvolatile memory, an HDD, and the like, a processor 112 including a CPU and the like, and a communication interface 113. These components are electrically connected to each other via a control line and a data line.

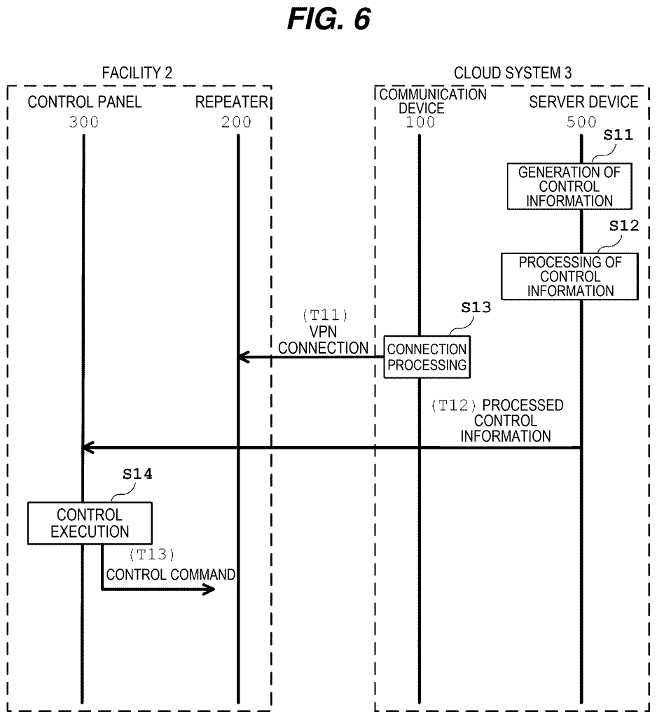

The memory 111 includes a RAM, a ROM, a nonvolatile memory, and an HDD, and functions as a storage unit. The ROM stores an instruction command for executing an application and an OS according to the present disclosure as a program. Such a program is loaded and executed by the processor 112. The RAM is used to write and read data while the program stored in the ROM is processed by the processor 112. The nonvolatile memory is a memory in which writing and reading of data are executed by execution of the program, and the data written here is stored even after the execution of the program ends. In the present disclosure, the memory 111 stores a program for executing each processing and the like described in processing sequences of FIGS. 6 to 8 (details of the processing will be described with reference to FIGS. 6 to 8). In addition, the memory 111 particularly stores a program related to VPN connection processing executed by the processor 112 described later.

The processor 112 includes a CPU (microcomputer), and functions as a control unit for controlling other connected components based on various programs stored in the memory 111. Specifically, the processor 112 reads a program for executing an application according to the present disclosure or a program for executing an OS from the memory 111 and executes the program. In the present disclosure, the processor 112 executes each processing and the like described in the processing sequences of FIGS. 6 to 8 (details of the processing will be described with reference to FIGS. 6 to 8). Note that the processor 112 may include a single CPU, or may include a plurality of CPUs.

In addition, the processor 112 performs processing based on a secret communication connection system using a virtual dedicated communication network (VPN) in order to establish secret communication connection to the repeater 200. More specifically, the processor 112 implements secure network extension based on communication protocols of IPsec and IKEv2, conceals a communication path, and performs VPN connection. In addition, the processor 112 encrypts the virtual dedicated communication network by ESP and AES-GCM to prevent falsification, thereby improving the security of the VPN connection. Here, AES-GCM is an encryption algorithm for achieving encryption processing and falsification prevention, and ESP is a protocol for executing the encryption algorithm. In other words, the processor 112 performs authentication, encryption, and tunneling using the communication protocol of IPsec and IKEv2 and the encryption system of ESP and AES-GCM, and establishes the VPN connection with the repeater 200. Note that the communication protocol and the encryption system used by the processor 112 are not limited to the above contents, and other systems can be used as long as the communication path to the repeater 200 can be concealed.

More specific examples of AES-GCM include AES-GCM-16-128, AES-GCM-16-192, or AES-GCM-16-256. By selecting and using any of these, encryption and falsification can be prevented.

Note that, from the viewpoint of improving security, the Diffie-Hellman key sharing may be used so that the past and future leaks are not affected even if there is an encryption key leak. For example, modp_2048 (group14), modp_2048_224 (modp_2048s224), modp_2048_256 (modp_2048s256), modp_1536 (group5), modp_3072 (group15), modp_4096 (group16), modp_8192 (group18), modp_1024 (group2), modp_1024_160 (modp_1024s160), ecp_256 (group19), ecp_384 (group20), ecp_521 (group21), or curve_25519 (group31) can be used as the Diffie-Hellman key sharing.

In addition, the processor 112 performs processing based on a secret communication connection system using a virtual dedicated communication network (VPN) in order to establish secret communication connection with the repeater 200. More specifically, the processor 112 performs processing corresponding to the request for the VPN connection from the repeater 200. That is, authentication related to the VPN connection from the repeater 200 is executed, and the VPN connection is permitted if there is no problem in the authentication. In addition to the VPN connection from the communication device 100 side described above, such VPN connection from the repeater 200 and the server device 500 side can be supported, so that VPN connection from both the communication device 100 and the repeater 200 can be made. Therefore, after communication interruption due to a certain problem occurs, it is possible to quickly restore the VPN connection when the problem is solved. Note that, in the present disclosure, such processing of the processor 112 is not essential, and may be selectively adopted as appropriate in consideration of information to be transmitted and received, the state of the facility 2, other environments, and the like.

Note that “secure” means “secure”, “safe”, “sturdy”, or “robust”. In the present disclosure, it means a state in which safety is secured so that information and a system are not illegally used by a third party in particular.

The communication interface 113 functions as a communication unit that transmits and receives information to and from the repeater 200, the server device 500, and other servers installed remotely via a communication processing circuit and an antenna. The communication processing circuit performs processing for transmitting and receiving programs, various types of information, and the like used in the processing system 1 from the repeater 200, the server device 500, and other server devices according to the progress of the processing. In the present disclosure, in particular, processed control information and processed request information related to the control panel 300 are received from the server device 500 via the communication interface 113, and each piece of the received information is transmitted to the repeater 200. In addition, output information (response information) is received from the repeater 200 via the communication interface 113, and the output information is transmitted to the server device 500.

The communication processing circuit operates based on processing for establishing secret communication connection to the repeater 200 and the server device 500 by the processor 112. For example, the communication processing circuit is processed based on a secret communication connection system using a virtual dedicated communication network (VPN). More specifically, the communication processing circuit is processed by the communication protocols of IPsec and IKEv2, and is also processed based on the encryption systems of ESP and AES-GCM. In addition, in the same cloud system 3, the secret communication connection is enabled using SSL.

Note that the communication processing circuit may be processed based on a broadband wireless communication system represented by the LTE system in addition to the processing based on the VPN system, or may be processed based on a system related to narrowband wireless communication such as a wireless LAN represented by IEEE802.11 or Bluetooth (registered trademark) or a system related to non-contact wireless communication. Furthermore, wired communication can be used instead of or in addition to wireless communication.

### 3. Configuration of Repeater 200

FIG. 3 is a block diagram illustrating an example of a configuration of the repeater 200 according to the first embodiment of the present disclosure. The repeater 200 does not need to include all components illustrated in FIG. 3, and may have a configuration in which a part is omitted, or may include other components.

The repeater 200 may use a general IoT router or a network device using a general-purpose OS (Windows (registered trademark), Linux (registered trademark), or Mac OS). Furthermore, the repeater 200 may be a router that includes an outlet into which a SIM or the like can be inserted and that is driven based on Linux (registered trademark). In the first embodiment of the present disclosure, various communication devices may be used as long as the communication devices can support the above-described VPN connection and multi-channelization to be described later.

According to FIG. 3, the repeater 200 includes a memory 211 including a RAM, a ROM, a nonvolatile memory, an HDD, and the like, a processor 212 including a CPU and the like, and a communication interface 213. These components are electrically connected to each other via a control line and a data line.

The memory 211 includes a RAM, a ROM, a nonvolatile memory, and an HDD, and functions as a storage unit. The ROM stores an instruction command for executing an application and an OS according to the present disclosure as a program. Such a program is loaded and executed by the processor 212. The RAM is used to write and read data while the program stored in the ROM is processed by the processor 212. The nonvolatile memory is a memory in which writing and reading of data are executed by execution of the program, and the data written here is stored even after the execution of the program ends. In addition, the memory 211 stores a program related to VPN connection processing executed by the processor 212 described later.

The processor 212 includes a CPU (microcomputer), and functions as a control unit for controlling other connected components based on various programs stored in the memory 211. Specifically, the processor 212 reads a program for executing an application according to the present disclosure or a program for executing an OS from the memory 211 and executes the program. Note that the processor 212 may include a single CPU, or may include a plurality of CPUs.

In addition, the processor 212 performs processing based on a secret communication connection system using a virtual dedicated communication network (VPN) in order to establish secret communication connection to the communication device 100. More specifically, the processor 212 implements secure network extension based on communication protocols of IPsec and IKEv2, conceals a communication path, and performs VPN connection. In addition, the processor 212 encrypts the virtual dedicated communication network by ESP and AES-GCM to prevent falsification, thereby improving the security of the VPN connection. Here, AES-GCM is an encryption algorithm for achieving encryption processing and falsification prevention, and ESP is a protocol for executing the encryption algorithm. In other words, the processor 212 performs authentication, encryption, and tunneling using the communication protocols of IPsec and IKEv2 and the encryption systems of ESP and AES-GCM, and establishes the VPN connection with the communication device 100. Note that the communication protocol and the encryption system used by the processor 212 are not limited to the above contents, and other systems can be used as long as the communication path to the communication device 100 can be concealed. Note that, in the present disclosure, such processing of the processor 212 is not essential, and may be selectively adopted as appropriate according to the necessity of the VPN connection from the repeater 200 side.

In addition, the processor 212 performs processing based on a secret communication connection system using a virtual dedicated communication network (VPN) in order to establish secret communication connection with the communication device 100. More specifically, the processor 212 performs processing corresponding to a VPN connection request from the communication device 100. That is, authentication related to the VPN connection from the communication device 100 is executed, and the VPN connection is permitted if there is no problem in the authentication.

Furthermore, the processor 212 may generate control information for supporting and controlling the electric installation 400 based on an input operation or another input signal from an input terminal connected in an emergency, and transmit the control information to the control panel 300. Here, an example of the emergency is a case where it is difficult to perform the secret communication connection from the outside due to a failure in the facility 2. In such a case, as an emergency response measure in the facility 2, control information is transmitted from the repeater 200 to the control panel 300, and the emergency response of the electric installation 400 is performed. As a result, it is possible to avoid uncontrollability due to communication interruption, realize continuous driving and operation of the electric installation 400, and achieve continuous operation of the facility 2. For example, information regarding the schedule of the electric installation 400 may be supplied to the control panel 300 via the repeater 200 to ensure minimum driving of the electric installation 400.

The communication interface 213 functions as a communication unit that transmits and receives information to and from the communication device 100 and other server devices installed remotely via the communication processing circuit and the antenna. The communication processing circuit performs processing for transmitting and receiving programs, various types of information, and the like used in the processing system 1 from the communication device 100 and other server devices according to the progress of the processing. In the present disclosure, in particular, processed control information and request information are received from the communication device 100 via the communication interface 213, and the output information is transmitted to the communication device 100.

The communication processing circuit operates based on processing for establishing secret communication connection with the communication device 100 by the processor 212. For example, the communication processing circuit is processed based on a secret communication connection system using a virtual dedicated communication network (VPN). More specifically, the communication processing circuit is processed by the communication protocols of IPsec and IKEv2, and is also processed based on the encryption systems of ESP and AES-GCM.

Note that the communication processing circuit may be processed based on a broadband wireless communication system represented by the LTE system in addition to the processing based on the VPN system, or may be processed based on a system related to narrowband wireless communication such as a wireless LAN represented by IEEE802.11 or Bluetooth (registered trademark) or a system related to non-contact wireless communication. Furthermore, wired communication can be used instead of or in addition to wireless communication.

### 4. Configuration of Control Panel 300

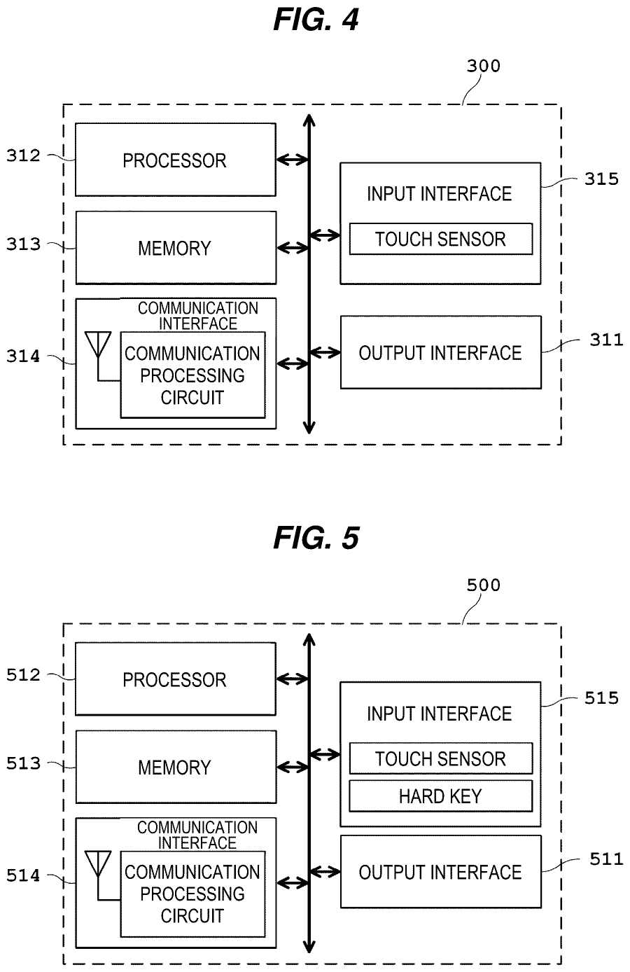

FIG. 4 is a block diagram illustrating an example of a configuration of the control panel 300 according to the first embodiment of the present disclosure. The control panel 300 does not need to include all components illustrated in FIG. 4, and may have a configuration in which a part is omitted, or may include other components.

The control panel 300 is a device that stores various electric devices or components for controlling the operation of the electric installation 400 of the facility 2 and protecting the electric installation at the time of abnormality. In addition, the control panel 300 is connected to the repeater 200 so as to be able to communicate with the repeater 200 in a wireless or wired manner, and can transfer various types of information such as control information or output information.

According to FIG. 4, the control panel 300 includes an output interface 311, a processor 312, a memory 313 including a RAM, a ROM, a non-volatile memory (in some cases, an HDD), or the like, a communication interface 314 including a communication processing circuit and an antenna, and an input interface 315 including a touch sensor. These components are electrically connected to each other via a control line and a data line.

The output interface 311 functions as an output unit that outputs an image captured by a camera and various displays output by executing the program according to the present disclosure to a device such as a display or a printer in response to an instruction of the processor 312. Note that such a display includes, for example, a liquid crystal display, an organic EL display, electronic paper, or the like.

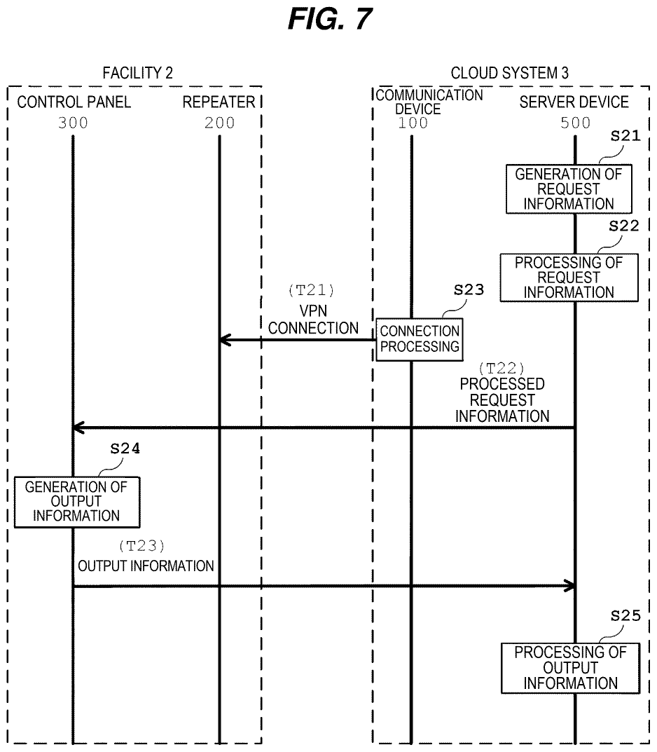

The processor 312 includes a CPU (microcomputer), and functions as a control unit that controls other connected components based on various programs stored in the memory 313. Specifically, the processor 312 reads a program for executing an application according to the present disclosure or a program for executing an OS from the memory 313 and executes the program. In the present disclosure, the processor 312 particularly executes each processing and the like described in the processing sequences of FIGS. 6 and 7 (details of the processing will be described with reference to FIGS. 6 and 7). Note that the processor 312 may be configured by a single CPU, or may be configured by combining a plurality of CPUs or GPUs.

The memory 313 includes a ROM, a RAM, a nonvolatile memory, an HDD, and the like, and functions as a storage unit. The ROM stores an instruction command for executing an application and an OS according to the present disclosure as a program. The RAM is used to write and read data while the program stored in the ROM is processed by the processor 312. The nonvolatile memory is a memory in which writing and reading of data are executed by execution of the program, and the data written here is stored even after the execution of the program ends. In the present disclosure, the memory 313 particularly stores a program for executing each processing and the like described in the processing sequences of FIGS. 6 and 7 (details of the processing will be described with reference to FIGS. 6 and 7). In addition, the memory 313 may store an independent control program that executes predetermined processing in an emergency such as communication interruption. As a result, even in a state where the VPN connection between the communication device 100 and the repeater 200 is impossible, the control panel 300 can generate and transmit a control command (third information) for supporting and controlling the electric installation 400, and the electric installation 400 is continuously operated even when the network is interrupted inside and outside the facility 2.

The communication interface 314 functions as a communication unit that transmits and receives information to and from the repeater 200 and the electric installation 400 installed in the facility 2 via the communication processing circuit and the antenna. The communication processing circuit performs processing for transmitting and receiving programs, various types of information, and the like used in the processing system 1 from the repeater 200 and the electric installation 400 according to the progress of the processing. In the present disclosure, in particular, a control command for controlling the operation of the electric installation 400 is transmitted to the electric installation 400, and processed control information and request information are received from the communication device 100 via the repeater 200.

The communication processing circuit is processed based on a broadband wireless communication system represented by an LTE system, but can also be processed based on a system related to narrowband wireless communication such as a wireless LAN represented by IEEE802.11 or Bluetooth (registered trademark) or a system related to non-contact wireless communication. Furthermore, wired communication can be used instead of or in addition to wireless communication.

The input interface 315 includes a touch sensor, and functions as an input unit that receives an instruction input related to execution of the program according to the present disclosure, an operation input for registering various types of information, and the like. The touch sensor is disposed so as to cover the output interface 311, and transmits information of the position coordinates corresponding to image data output from the output interface 311 to the display to the processor 312. As a system of the touch sensor, a known system such as a resistive film system, a capacitive coupling system, or an ultrasonic surface acoustic wave system can be used. In the present disclosure, the touch sensor detects a swipe operation or a tap operation on each icon or the like displayed on the output interface 311 by an indicator. Note that, although the input interface 315 included in the control panel 300 is used in the present disclosure, it is also possible to use the input interface 315 connected wirelessly or by wire to a main body including the processor 312 and the like, such as a mouse.

### 5. Configuration of Server Device 500

FIG. 5 is a block diagram illustrating an example of a configuration of the server device 500 according to the first embodiment of the present disclosure. The server device 500 does not need to include all components illustrated in FIG. 5, and may have a configuration in which a part is omitted, or may include other components.

The server device 500 is typically a terminal device capable of wireless communication represented by a laptop computer or a desktop computer smartphone, but is not limited to the device. For example, any device capable of executing the program according to the present disclosure, such as a smartphone, a feature phone, a portable information terminal, a PDA, a portable game machine, or a stationary game machine, can be suitably applied as the terminal device. Further, a plurality of server devices 500 may communicate with the communication device 100, and each terminal does not always need to be the same type or the same terminal device, and may be different types of terminal devices.

According to FIG. 5, the server device 500 includes an output interface 511, a processor 512, a memory 513 including a RAM, a ROM, a non-volatile memory (in some cases, an HDD), or the like, a communication interface 514 including a communication processing circuit and an antenna, and an input interface 515 including a touch sensor and a hard key. These components are electrically connected to each other via a control line and a data line.

The output interface 511 functions as an output unit that outputs an image captured by a camera (not illustrated) or various displays output by executing a program according to the present disclosure to a device such as a display or a printer according to an instruction of the processor 512. Note that such a display includes, for example, a liquid crystal display, an organic EL display, electronic paper, or the like.

The processor 512 includes a CPU (microcomputer), and functions as a control unit that controls other connected components based on various programs stored in the memory 513. Specifically, the processor 512 reads a program for executing an application according to the present disclosure or a program for executing an OS from the memory 513 and executes the program. In the present disclosure, the processor 512 particularly executes each processing and the like described in the processing sequences of FIGS. 6 to 8 (details of the processing will be described with reference to FIGS. 6 to 8). Note that the processor 512 may be configured by a single CPU, or may be configured by combining a plurality of CPUs or GPUs.

In addition, the processor 512 performs processing based on SSL in order to establish secret communication connection to the communication device 100. Here, since the server device 500 and the communication device 100 exist in the same cloud system 3, secret communication connection is enabled only by performing normal communication connection. Note that the method of the secret communication connection used by the processor 512 is not limited to the above content, and other methods can be used as long as the communication path for the communication device 100 existing in the same cloud system 3 can be concealed.

The memory 513 includes a ROM, a RAM, a nonvolatile memory, an HDD, and the like, and functions as a storage unit. The ROM stores an instruction command for executing an application and an OS according to the present disclosure as a program. The RAM is used to write and read data while the program stored in the ROM is processed by the processor 512. The nonvolatile memory is a memory in which writing and reading of data are executed by execution of the program, and the data written here is stored even after the execution of the program ends. In the present disclosure, the memory 513 particularly stores a program for executing each processing and the like described in the processing sequences of FIGS. 6 to 8 (details of the processing will be described with reference to FIGS. 6 to 8).

The communication interface 514 functions as a communication unit that transmits and receives information to and from the communication device 100 and other server devices installed remotely via the communication processing circuit and the antenna. The communication processing circuit performs processing for transmitting and receiving programs, various types of information, and the like used in the processing system 1 from the communication device 100 and other server devices according to the progress of the processing. In the present disclosure, in particular, processed control information and request information related to the control panel 300 are transmitted to the communication device 100 via the communication interface 514, and unprocessed output information is received from the communication device 100.

The communication processing circuit operates based on processing for establishing secret communication connection to the communication device 100 by the processor 512. For example, the communication processing circuit is processed based on SSL.

Note that, in addition to the processing based on SSL, the communication processing circuit may be processed based on a broadband wireless communication system represented by the LTE system, or may be processed based on a system related to narrowband wireless communication such as a wireless LAN represented by IEEE802.11 or Bluetooth (registered trademark) or a system related to non-contact wireless communication. Furthermore, wired communication can be used instead of or in addition to wireless communication.

The input interface 515 includes a touch panel, a hard key, and the like, and functions as an input unit that receives an instruction input related to execution of the program according to the present disclosure, an operation input for registering various types of information, and the like. The touch sensor is disposed so as to cover the output interface 511, and transmits information of the position coordinates corresponding to image data output from the output interface 511 to the display to the processor 512. As a system of the touch sensor, a known system such as a resistive film system, a capacitive coupling system, or an ultrasonic surface acoustic wave system can be used. In the present disclosure, the touch sensor detects a swipe operation or a tap operation on each icon or the like displayed on the output interface 511 by an indicator. Note that, although the input interface 515 included in the server device 500 is used in the present disclosure, the input interface 515 connected wirelessly or by wire to a main body including the processor 512 and the like, such as a mouse, can also be used.

### 6. Processing Sequence Executed by Processing System 1

### (A) Processing Related to Remote Control by Server Device 500

FIG. 6 is a diagram illustrating a processing sequence executed among the communication device 100, the repeater 200, the control panel 300, and the server device 500 according to the first embodiment of the present disclosure. Specifically, FIG. 6 is a diagram illustrating a processing sequence from transmission of control information from the server device 500 installed in a place different from the facility 2 to the control panel 300 via the communication device 100 and the repeater 200 to control of the electric installation 400 in the facility 2.

According to FIG. 6, the processor 512 of the server device 500 periodically generates control information (first information) according to a predetermined program stored in the memory 513 (S11). The control information includes information regarding the facility 2, the repeater 200, the control panel 300, and the electric installation 400, information regarding specific control contents of the electric installation 400, and the like. Note that the control information does not need to include all the above-described information, and the included information can be appropriately changed if the control target and the control content are known.

Thereafter, the processor 512 of the server device 500 processes the control information according to the predetermined program stored in the memory 513 (S12). Specifically, the processor 512 rewrites or converts the control information into a format corresponding to the control panel 300 based on the information of the control panel 300 included in the control information. That is, the processor 512 processes the control information generated based on the rule handled in the server device 500, and generates control information (second information) that can be executed in the control panel 300. This is because the facility 2, which is a closed space, and the cloud system 3, which is a different space, have different information handling, generation rules, and the like. Note that the processing in S12 may be executed simultaneously with or after the VPN connection processing described later.

Next, the processor 112 of the communication device 100 periodically executes processing related to the VPN connection with the repeater 200 according to a predetermined program stored in the memory 111 (S13). Specifically, the processor 112 periodically reads and executes the program related to the VPN connection stored in the memory 111. More specifically, since the program includes information of the repeater 200 of the connection destination and the control panel 300, the processor 512 specifies the repeater 200 connected to the control panel 300 of the electric installation 400 to be controlled and sets the repeater as the VPN connection destination. In addition, the processor 512 performs authentication processing, encryption processing, and tunneling processing based on a communication protocol and an encryption system set in advance. Thereafter, authentication processing for permitting the VPN connection by the processor 212 is also performed on the repeater 200 side, and the VPN connection between the communication device 100 and the repeater 200 is established (T11). Thereafter, the processor 512 of the server device 500 transmits the processed control information (second information) to the communication device 100 via the communication interface 514 and to the repeater 200 via the VPN connection (T12). Here, transmission of information between the server device 500 and the communication device 100 is performed in a secret state, and transmission of information between the communication device 100 and the repeater 200 is also performed in a secret state by the VPN connection.

The processor 212 of the repeater 200 transmits the received processed control information to the control panel 300 via the communication interface 213 and the intra-facility network. Here, since the repeater 200 is positioned as a window for the VPN connection, the information received in the repeater 200 is processed into a format corresponding to the control panel 300, and the repeater 200 and the control panel 300 are communicably connected by wired or wireless communication, the repeater 200 transmits the processed control information to the control panel 300 as it is. That is, the processed control information is transmitted from the server device 500 to the control panel 300 via the repeater 200, additional processing is unnecessary in the repeater 200, and the repeater 200 can be simplified. Therefore, FIG. 6 illustrates that the processed control information is transmitted from the communication device 100 to the control panel 300 via the repeater 200 (T12).

When the processed control information is received via the communication interface 314 in the control panel 300, the processor 312 of the control panel 300 executes control based on the processed control information (S14). Specifically, the processor 312 determines the electric installation 400 to be controlled and the control content from the processed control information. Further, the processor 312 transmits a control command to the electric installation 400 based on the determined control content (T13). In the electric installation 400, driving or operation is performed based on the control command. Note that the processor 312 may drive another device provided in the control panel 300 to execute driving, operation, maintenance, or inspection of the electric installation 400.

### (B) Processing Related to Remote Information Collection by Server Device 500

FIG. 7 is a diagram illustrating a processing sequence executed among the communication device 100, the repeater 200, the control panel 300, and the server device 500 according to the first embodiment of the present disclosure. Specifically, FIG. 7 is a diagram illustrating a processing sequence from transmission of request information from the server device 500 installed in a place different from the facility 2 to the control panel 300 via the communication device 100 and the repeater 200 to collection of output information related to the electric installation 400 in the facility 2.

According to FIG. 7, the processor 512 of the server device 500 periodically generates request information (first information) according to a predetermined program stored in the memory 513 (S21). The request information includes information regarding the facility 2, the repeater 200, the control panel 300, and the electric installation 400, information regarding specific output contents by the electric installation 400, and the like. Note that the request information does not need to include all the above-described information, and the included information can be appropriately changed if the request target and the request content are known.

Thereafter, the processor 512 of the server device 500 processes the request information according to the predetermined program stored in the memory 513 (S22). Specifically, the processor 512 rewrites or converts the control information into a format corresponding to the control panel 300 based on the information of the control panel 300 included in the request information. That is, the processor 512 processes the control information generated based on the rule handled in the server device 500, and generates request information (second information) that can be executed in the control panel 300. This is because the facility 2, which is a closed space, and the cloud system 3, which is a different space, have different information handling, generation rules, and the like. Note that the processing in S22 may be executed simultaneously with or after the VPN connection processing described later.

Next, the processor 112 of the communication device 100 periodically executes processing related to the VPN connection with the repeater 200 according to the predetermined program stored in the memory 111 (S23). Specifically, the processor 112 periodically reads and executes the program related to the VPN connection stored in the memory 111. More specifically, since the program includes information of the repeater 200 of the connection destination and the control panel 300, the processor 512 specifies the repeater 200 connected to the control panel 300 of the electric installation 400 to be requested, and sets the repeater as the VPN connection destination. In addition, the processor 512 performs authentication processing, encryption processing, and tunneling processing based on a communication protocol and an encryption system set in advance. Thereafter, authentication processing for permitting the VPN connection by the processor 212 is also performed on the repeater 200 side, and the VPN connection between the communication device 100 and the repeater 200 is established (T21). Thereafter, the processor 512 of the server device 500 transmits the processed request information (second information) to the communication device 100 via the communication interface 514 and to the repeater 200 via the VPN connection (T22). Here, transmission of information between the server device 500 and the communication device 100 is performed in a secret state, and transmission of information between the communication device 100 and the repeater 200 is also performed in a secret state by the VPN connection.

The processor 212 of the repeater 200 transmits the received processed request information to the control panel 300 via the communication interface 213 and the intra-facility network. Here, since the repeater 200 is positioned as a window for VPN connection, the information received in the repeater 200 is processed into a format corresponding to the control panel 300, and the repeater 200 and the control panel 300 are communicably connected by wired or wireless communication, the repeater 200 transmits the processed request information to the control panel 300 as it is. That is, the processed request information is transmitted from the server device 500 to the control panel 300 via the repeater 200, additional processing is unnecessary in the repeater 200, and the repeater 200 can be simplified. Therefore, FIG. 7 illustrates that the processed request information is transmitted from the communication device 100 to the control panel 300 via the repeater 200 (T22).

When the processed request information is received in the control panel 300 via the communication interface 314, the processor 312 of the control panel 300 generates output information based on the processed request information (S24). Specifically, the processor 312 determines the electric installation 400 which is the request target and the request content from the processed request information. Furthermore, the processor 312 reads various types of information related to the drive, operation, or the like of the electric installation 400 from the memory 313, and forms output information corresponding to the request content. Here, information regarding driving or operation of the electric installation 400, information obtained in the electric installation 400, or the like corresponds to the output information as an example. In addition, the processor 312 transmits the information to the repeater 200 via the communication interface 314 and the intra-facility network (T23).

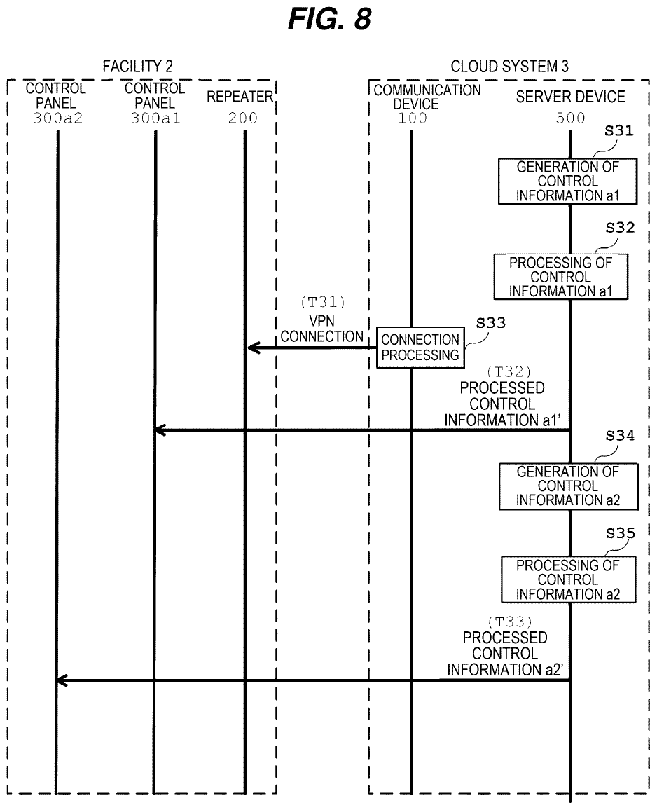

The processor 212 of the repeater 200 transmits the received unprocessed output information to the communication device 100 via the communication interface 213 and the VPN. Here, since the repeater 200 is positioned as a window for VPN connection and processing of the output information is executed in the communication device 100, the repeater 200 transmits the unprocessed output information to the communication device 100 as it is. That is, the unprocessed output information is transmitted from the control panel 300 to the communication device 100 via the repeater 200, additional processing is unnecessary in the repeater 200, and the repeater 200 can be simplified. Therefore, FIG. 8 illustrates that unprocessed output information is transmitted from the control panel 300 to the communication device 100 via the repeater 200 (T25).

When the newly generated output information is received in the communication device 100 via the communication interface 113, the output information is transmitted as it is to the server device 500 via the communication connection in the cloud system 3. Therefore, FIG. 8 illustrates that the output information transmitted from the control panel 300 reaches the server device 500 via the repeater 200 and the communication device 100 (T23).

When the newly generated output information is received in the server device 500 via the communication interface 514, the processor 512 of the server device 500 processes the output information (S25). Specifically, the processor 512 determines a transmission source of the received output information by managing the request information and the output information in association with each other. In addition, the processor 512 rewrites or converts the information into a format corresponding to the server device 500. That is, the processor 512 processes the output information generated based on the rule handled in the control panel 300, and generates output information (second information) that can be used in the server device 500.

### (C) Processing Related to Remote Control for Plurality of Control Panels by Server Device 500

FIG. 8 is a diagram illustrating a processing sequence executed among the communication device 100, the repeater 200, a control panel 300a1, a control panel 300a2, and the server device 500 according to the first embodiment of the present disclosure. Specifically, FIG. 8 is a diagram illustrating a processing sequence for transmitting the control information from the server device 500 installed in a place different from the facility 2 to the two control panels 300a1 and 300a2 via the communication device 100 and the repeater 200. That is, in FIG. 8, when there are a plurality of control targets (electric installations 400) in the facility 2, it is assumed that control information is transmitted to a control panel of each control target to control the plurality of electric installations.

According to FIG. 8, the processor 512 of the server device 500 periodically generates control information a1 (first information) according to the predetermined program stored in the memory 513 (S31). The control information a1 includes information regarding the facility 2, the repeater 200, the control panel 300a1, and the electric installation 400, information regarding specific control contents of the electric installation 400, and the like.

Thereafter, the processor 512 of the server device 500 processes the control information a1 according to the predetermined program stored in the memory 513 (S32). Specifically, the processor 512 rewrites or converts the control information a1 into a format corresponding to the control panel 300a1 based on the information of the control panel 300a1 included in the control information a1. That is, the processor 512 processes the control information generated based on the rule handled in the server device 500, and generates control information a1′ (second information) that can be executed in the control panel 300a1. This is because the facility 2, which is a closed space, and the cloud system 3, which is a different space, have different information handling, generation rules, and the like. Note that the processing in S32 may be executed simultaneously with or after the VPN connection processing described later.

Next, the processor 112 of the communication device 100 periodically executes processing related to the VPN connection with the repeater 200 according to the predetermined program stored in the memory 111 (S33). Specifically, the processor 112 periodically reads and executes the program related to the VPN connection stored in the memory 111. More specifically, since the program includes information of the repeater 200 of the connection destination and each control panel, the processor 512 specifies the repeater 200 connected to each control panel of the electric installation 400 to be controlled and sets the repeater as the VPN connection destination. In addition, the processor 512 performs authentication processing, encryption processing, and tunneling processing based on a communication protocol and an encryption system set in advance. Thereafter, authentication processing for permitting the VPN connection by the processor 212 is also performed on the repeater 200 side, and the VPN connection between the communication device 100 and the repeater 200 is established (T31). Thereafter, the processor 512 of the server device 500 transmits the processed control information a1′ (second information) to the communication device 100 via the communication interface 514 and to the repeater 200 via the VPN connection (T32). Here, transmission of information between the server device 500 and the communication device 100 is performed in a secret state, and transmission of information between the communication device 100 and the repeater 200 is also performed in a secret state by the VPN connection.

The processor 212 of the repeater 200 transmits the received processed control information a1′ to the control panel 300 via the communication interface 213 and the intra-facility network. Here, since the repeater 200 is positioned as a window for VPN connection, the information received in the repeater 200 is processed into a format corresponding to the control panel 300a1, and the repeater 200 and the control panel 300a1 are communicably connected by wired or wireless communication, the repeater 200 transmits the processed control information a1′ to the control panel 300 as it is. That is, the processed control information a1′ is transmitted from the server device 500 to the control panel 300a1 via the repeater 200, additional processing is unnecessary in the repeater 200, and the repeater 200 can be simplified. Therefore, FIG. 8 illustrates that the processed control information a1′ is transmitted from the communication device 100 to the control panel 300a1 via the repeater 200 (T32). Thereafter, the control panel 300a1 executes control of the connected electric installation 400 based on the control information a1′.

Next, the processor 512 of the server device 500 periodically generates the control information a2 (first information) according to the predetermined program stored in the memory 513 (S34). The control information a2 includes information regarding the facility 2, the repeater 200, the control panel 300a2, and the electric installation 400, information regarding specific control contents of the electric installation 400, and the like. More specifically, the control panel 300a2 different from the control panel 300a1 described above generates the control information a2 in order to control another electric installation 400.

Thereafter, the processor 512 of the server device 500 processes the control information a2 according to the predetermined program stored in the memory 513 (S35). Specifically, the processor 512 rewrites or converts the control information into a format corresponding to the control panel 300a1 based on the information of the control panel 300a2 included in the control information a2. That is, the processor 512 processes the control information a2 generated based on the rule handled in the server device 500, and generates the control information a2′ (second information) that can be executed in the control panel 300a1. This is because the facility 2, which is a closed space, and the cloud system 3, which is a different space, have different information handling, generation rules, and the like. Note that the processing in S35 may be executed simultaneously with or before the above-described VPN connection processing.

Next, since the VPN connection between the communication device 100 and the repeater 200 continues, the processor 512 of the server device 500 transmits the processed control information a2′ (second information) to the communication device 100 via the communication interface 514 and to the repeater 200 via the VPN connection (T33). When the VPN connection between the communication device 100 and the repeater 200 is disconnected, the processor 112 of the communication device 100 executes S33 again to establish the VPN connection, and the control information a2′ is transmitted in a state where the VPN connection is established. The re-establishment of the VPN connection may be performed from the repeater 200 side. Thereafter, the control panel 300a2 controls the connected electric installation 400 based on the control information a2′.

As described above, in the communication device 100, since the VPN connection to the facility 2 and the information processing to each control panel are performed, versatility as the processing system 1 can be enhanced. That is, even in a case where there are a plurality of electric installations 400 that needs to be managed, it is possible to easily cope with various electric installations 400 while safely and reliably performing information communication.

### (D) Processing Related to Remote Control in Comparative Example

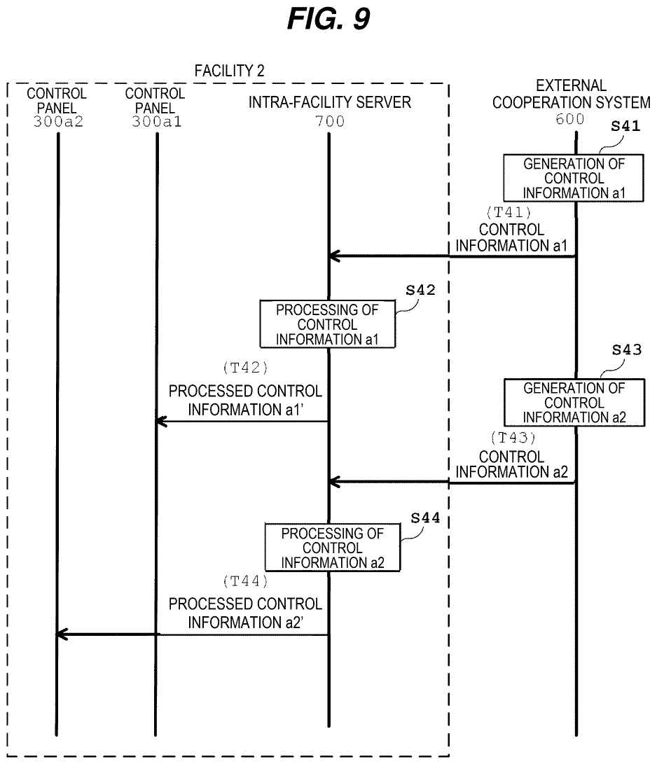

FIG. 9 is a diagram illustrating a processing sequence of remote control in a comparative example of a mode different from the processing system 1 according to the first embodiment of the present disclosure. In the comparative example, the communication device 100 is not provided, and an intra-facility server 700 is provided inside the facility 2 instead of the communication device 100. The intra-facility server 700 is a server device that operates the control panel in cooperation with an external operation terminal. In addition, an external cooperation system 600 having a configuration similar to that of the server device 500 described above is provided outside the facility. Since the configuration of the external cooperation system 600 is similar to that of the server device 500, the description thereof will be omitted.

According to FIG. 9, the processor of the external cooperation system 600 periodically generates the control information a1 according to the predetermined program stored in the memory (S41). The control information a1 includes information regarding the control panel 300a1 and the electric installation 400, information regarding specific control contents of the electric installation 400, and the like. Thereafter, the processor of the external cooperation system 600 transmits the generated control information a1 to the intra-facility server 700 via the communication interface and the Internet (T41). Here, secret communication connection such as the VPN connection is not established between the external cooperation system 600 and the intra-facility server 700, and information is transmitted and received in a low security state. Unlike the secure state as in the above-described first embodiment, there is a high possibility that a problem such as information leak occurs.

Next, when the newly generated control information a1 is received via the communication interface in the intra-facility server 700, the processor of the intra-facility server 700 processes the control information a1 (S42). Specifically, the processor of the intra-facility server 700 rewrites or converts the control information a1 into a format corresponding to the control panel 300a1 based on the information of the control panel 300a1 included in the control information a1. That is, the processor of the intra-facility server 700 processes the control information a1 generated based on the rule handled in the external cooperation system 600, and generates the control information a1′ that can be executed in the control panel 300a1. As described above, the information processing corresponding to the control panel 300a1 is performed in the facility 2, and the burden on the facility 2 (the burden on the intra-facility server 700) increases as compared with the above-described first embodiment.

Next, the processor of the intra-facility server 700 transmits the processed control information a1′ to the control panel 300a1 via the communication interface (T42). Thereafter, the control panel 300a1 executes control of the connected electric installation 400 based on the control information a1′.

Next, the processor of the external cooperation system 600 periodically generates the control information a2 according to a predetermined program stored in the memory (S43). The control information a2 includes information regarding the control panel 300a2 and the electric installation 400, information regarding specific control contents of the electric installation 400, and the like. Thereafter, the processor of the external cooperation system 600 transmits the generated control information a2 to the intra-facility server 700 via the communication interface and the Internet (T43). Here, secret communication connection such as VPN connection is not established between the external cooperation system 600 and the intra-facility server 700, and information is transmitted and received in a low security state.

Next, when the newly generated control information a2 is received via the communication interface in the intra-facility server 700, the processor of the intra-facility server 700 processes the control information a2 (S44). Specifically, the processor of the intra-facility server 700 rewrites or converts the control information a2 into a format corresponding to the control panel 300a2 based on the information of the control panel 300a2 included in the control information a2. That is, the processor of the intra-facility server 700 processes the control information a2 generated based on the rule handled in the external cooperation system 600, and generates the control information a2′ that can be executed in the control panel 300a2. As described above, the information processing corresponding to the control panel 300a2 is also performed in the facility 2, and the burden on the facility 2 (the burden on the intra-facility server 700) further increases.

Next, the processor of the intra-facility server 700 transmits the processed control information a1′ to the control panel 300a1 via the communication interface (T42). Thereafter, the control panel 300a1 executes control of the connected electric installation 400 based on the control information a1′.

As described above, in the comparative example, not only safe and reliable information communication is difficult, but also information processing in the facility 2 is added, and a total burden in the facility 2 becomes very large. In particular, in a facility having a large number of control panels and electric installations, the burden becomes significant, and it becomes difficult to operate as a processing system. On the other hand, in the first embodiment described above, secret information communication such as VPN is established by the communication device 100 outside the facility 2 to enable secure communication, and information processing can be collectively handled on the communication device 100 side, so that the burden on the facility 2 is reduced and the operation of the processing system 1 can be easily performed.

### 7. Application Example of Processing System 1

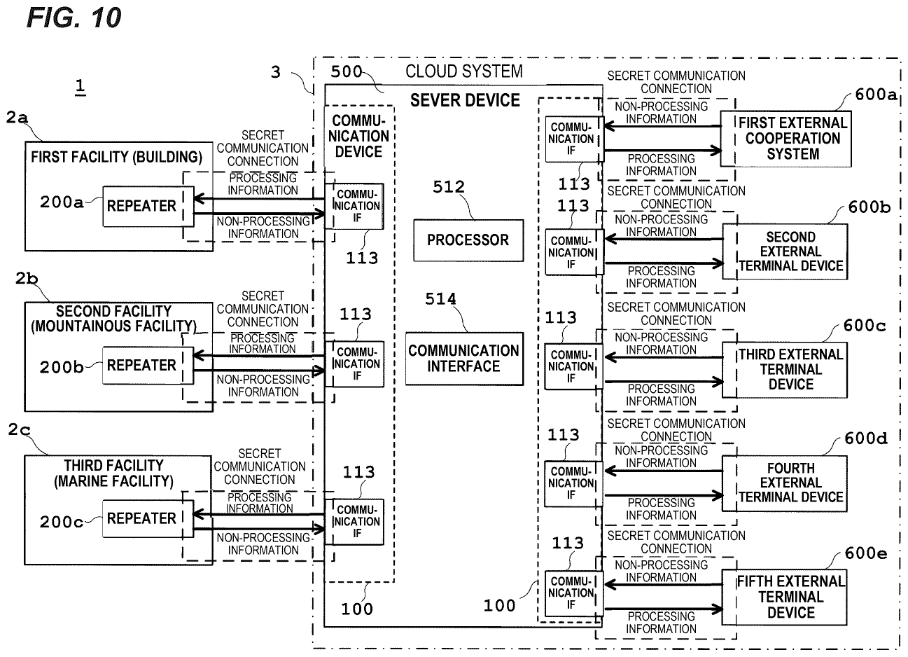

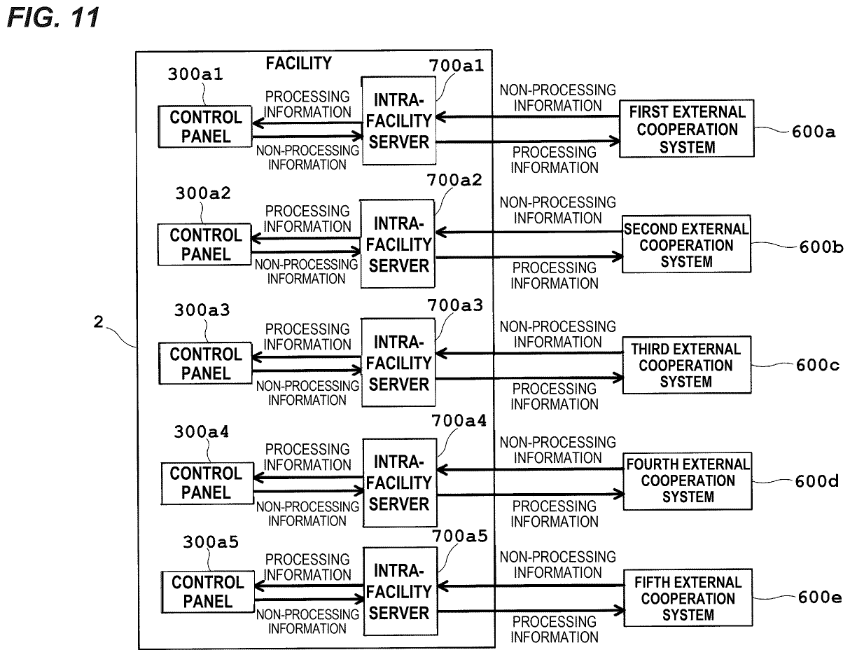

In the first embodiment described above, for convenience of description, it is assumed that there is one facility and one server device, but transmission and reception of information such as control or output request may be performed between one communication device 100, a plurality of external cooperation systems, and a plurality of facilities. With such a case as an application example, a configuration and an effect thereof will be described with reference to FIGS. 10 and 11. However, since the configuration and function (operation) of each device are the same as those of the first embodiment described above, the description thereof will be omitted.

Here, FIG. 10 is a diagram illustrating a schematic configuration of an application example of the processing system 1 according to the first embodiment of the present disclosure. On the other hand, FIG. 11 is a diagram illustrating a schematic configuration of a comparative example having a configuration different from that of the application example.

First, as illustrated in FIG. 10, the communication device 100 can use the communication interface 113 to establish secret communication connection having as an example the VPN connection with a first external cooperation system 600a, a second external cooperation system 600b, a third external cooperation system 600c, a fourth external cooperation system 600d, and a fifth external cooperation system 600e existing in the same cloud system. In such a state, the processor 512 of the server device 500 receives unprocessed information (control information or request information) from each external cooperation system via the communication interface 514 and the secret communication network, and transmits processed information (control information or request information) corresponding to each cooperation system. That is, the processor 512 of the server device 500 not only performs secret communication with external cooperation systems existing in the same cloud system 3, but also collectively generates processed information corresponding to each external cooperation system.

Further, as illustrated in FIG. 10, the communication device 100 can perform secret communication with a first facility (building) 2a, a second facility (mountainous facility) 2b, and a third facility (marine facility) 2c, which are examples of the facility 2. Specifically, the processor 112 of the communication device 100 can use the communication interface 113 to establish secret communication connection having as an example the VPN connection with a repeater 200a of the first facility 2a, a repeater 200b of the second facility 2b, and a repeater 200c of the third facility 2c. In such a state, the processor 512 of the server device 500 transmits the processed information corresponding to the control panel of each facility to each repeater via the communication interface 514 and the secret communication network, and receives the unprocessed information via the repeater installed in each facility. That is, the processor 512 of the server device 500 not only performs secret communication with the repeaters existing in different facilities, but also collectively generates processed information (control information or request information) corresponding to the control panel and the electric installation installed in each facility.

As described above, it is possible to easily transmit and receive information corresponding to each terminal device and the control panel while performing secret communication by relaying the communication device 100. Therefore, each external cooperation system and each facility do not set a common rule regarding communication and information, and information communication in a secure environment is performed in a state in which the burden on each place is reduced. That is, by reducing the processing burden of the processing system 1 as a whole and performing secure information communication, it is possible to reduce the cost of the processing system 1. In addition, secure information communication between a plurality of external cooperation systems and a plurality of facilities is possible, and it can be said that versatility as the processing system 1 is very high.

On the other hand, in the comparative example illustrated in FIG. 11, unlike the first embodiment of the present disclosure, the communication device 100 and the server device 500 are not provided, and intra-facility servers 700a1 to 700a5 are provided inside the facility 2 instead of the communication device 100. Each intra-facility server can communicate with a plurality of external cooperation systems (first external cooperation system 600a, second external cooperation system 600b, third external cooperation system 600c, fourth external cooperation system 600d, and fifth external cooperation system 600e) via the Internet. In such a state, the processor of each intra-facility server receives unprocessed information (control information or request information) from each external cooperation system via the communication interface and the Internet, and transmits processed information (control information or request information) corresponding to each external cooperation system. That is, the processor of each intra-facility server performs information communication that is not in the secret state with the external cooperation system existing outside, and generates processed information corresponding to each external cooperation system.

As illustrated in FIG. 11, five control panels (control panels 300a1 to 300a5) are installed in the facility 2. Each intra-facility server can communicate with each corresponding control panel via a wireless or wired communication line in the facility. In such a state, the processor of each intra-facility server receives unprocessed information (output information) from each control panel via the communication interface and the intra-facility line, and transmits processed information (control information or request information) corresponding to each control panel. That is, the processor of each intra-facility server coordinates information communication and generates processed information corresponding to each control panel also inside the facility 2.

As described above, each intra-facility server needs to process information to the outside and process information to the outside while coordinating information communication with the outside and the inside, and the load on each intra-facility server becomes very large. However, the processing capability of each intra-facility server that can be installed in the facility 2 is limited, and it is very difficult to perform processing on the inside and outside as illustrated in FIG. 11. If such an intra-facility server is installed for each facility, for an administrator who manages a plurality of facilities, the cost of the entire processing system increases, and the management itself becomes complicated. In addition, by providing a plurality of such intra-facility servers, the cost in the facility 2 also increases. On the other hand, it is conceivable to integrate each intra-facility server into one, but not only the load of one intra-facility server is further increased, but also the cost is further increased.

Furthermore, if access from a plurality of external cooperation systems is permitted in a state where the intra-facility server 700 does not perform the secret communication connection, a security problem is more likely to occur. Therefore, the risk of information leak or the like in the facility 2 increases, and the reliability of the processing system is impaired.

### Second Embodiment

### 8. Configuration of Processing System 1 According to Another Embodiment of Present Disclosure

In the first embodiment described above, VPN connection established between a cloud system 3 and a facility 2 is always a fixed path. However, a plurality of VPN connections may be established between a communication device 100 and the facility 2, and one VPN connection for transmitting and receiving information may be selected from the plurality of VPN connections. That is, in the second embodiment, multi-channelization is performed. Such a mode will be described below as the second embodiment, but the same configurations and the same components as those of the first embodiment will be denoted by the same reference numerals, the description thereof will be omitted, and different configurations and operations will be described.

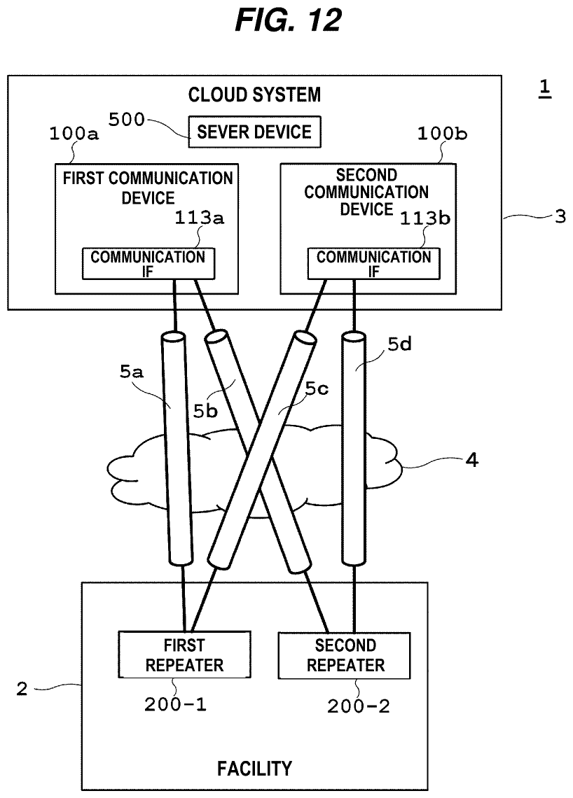

FIG. 12 is a diagram illustrating a schematic configuration of the processing system 1 according to the second embodiment of the present disclosure. As illustrated in FIG. 12, unlike the first embodiment, a cloud system 3 according to the second embodiment includes two communication devices (a first communication device 100a and a second communication device 100b). In addition, each communication device separately includes communication interfaces (a first communication interface 113a and a second communication interface 113b). In addition, two repeaters (a first repeater 200-1 and a second repeater 200-2) are provided in a facility 2.

Furthermore, the first communication interface 113a can perform information communication with the first repeater 200-1 and the second repeater 200-2 via the Internet 4. Similarly, the second communication interface 113b can also perform information communication with the first repeater 200-1 and the second repeater 200-2 via the Internet 4. Therefore, there are four communication paths that can establish communication connection between the communication device 100 and the facility 2.

In such a state, a processor 112 of the communication device 100 can establish the VPN connection in each of the communication paths. Therefore, as illustrated in FIG. 12, the VPN connection 5a is established between the first communication interface 113a and the first repeater 200-1, the VPN connection 5b is established between the first communication interface 113a and the second repeater 200-2, the VPN connection 5c is established between the second communication interface 113b and the first repeater 200-1, and the VPN connection 5d is established between the second communication interface 113b and the second repeater 200-2.

In addition, the processors of the two communication devices (first communication device 100a and second communication device 100b) determine the VPN connection to actually transmit and receive information in consideration of the communication speed (data transfer speed) of each VPN connection, the future communication speed, the stability of the line, and the like. Specifically, the processors of the two communication devices use a border gateway protocol (BGP). That is, the processors of the two communication devices use the border gateway protocol (BGP) in addition to the communication protocols of IPsec and IKEv2 and the encryption systems of ESP and AES-GCM described above, and perform selection of an optimal path from a plurality of VPN connection paths, selection of a high-speed detour path at the time of a failure, and the like. Here, the path selection by the BGP is also performed by the first repeater 200-1 and the second repeater 200-2 in the facility 2. That is, when one is selected from the four VPN connections, the VPN connection, which is one optimal path, is selected in such a manner that the communication device 100a, the communication device 100b, the first repeater 200-1, and the second repeater 200-2 cooperate (share information) with each other by the BGP.

As described above, there are a plurality of communication paths through which the VPN connection can be established, and by selecting the optimum path from the plurality of established VPN connections, a network between the communication device 100 and the facility 2 is made redundant. With the redundancy, unauthorized access from the outside and the like can be further reduced, and more secure information communication can be performed.

As a matter of course, the number of communication interfaces of the communication device 100 and the number of repeaters of the facility 2 are not limited to the state of FIG. 12, and each number can be appropriately increased or decreased as long as a plurality of communication paths can be provided. For example, each number may be further increased to increase the number of communication paths, thereby further increasing security. On the other hand, since the expansion of the repeater on the facility 2 side also has a cost problem, the number of repeaters may be determined in consideration of the viewpoint of ensuring security and the viewpoint of cost.

Note that the cloud system 3 may include one communication device including two communication interfaces (the first communication interface 113a and the second communication interface 113b) instead of including the two communication devices 100a and 100b. Even in this case, similarly to the second embodiment, four VPN connections are possible, and any one of the VPN connections is selected when information is transmitted.

### 9. Summary of Embodiments of Present Disclosure

A cloud system 3 according to an embodiment of the present disclosure includes a processor 112 and a processor 512, and these processors are configured to execute processing for generating first information according to a type of an electric installation 400 installed in a different facility 2, processing the first information in accordance with a control panel 300 of the electric installation 400 to generate second information, establishing secret communication connection with at least one repeater 200 installed in the different facility 2, and transmitting the second information to the control panel 300 via the repeater 200 in a secret state. With such a configuration, the operations of various electric installations 400 provided in the facility 2 can be controlled remotely, safely, and accurately.

In the above configuration, the secret communication connection may be performed by a secret communication connection system using a virtual dedicated communication network. Further, the secret communication connection system may be IPsec and IKEv2. With such a configuration, the second information can be transmitted in a more secret state, and safety and accuracy of transmission and reception of information can be improved.

In the above configuration, the secret communication connection may include encrypting the virtual dedicated communication network. Further, the encryption of the virtual dedicated communication network may be performed by ESP and AES-GCM. With such a configuration, the second information can be transmitted in a more secret state, and safety and accuracy of transmission and reception of information can be improved.

In the above configuration, at least one processor 112 may select an optimum path from one of a plurality of secret communication connections established up to the repeater 200 and transmit the second information. With such a configuration, multi-channelization as a processing system is realized, and safety and accuracy of transmission and reception of information can be improved.

A processing system 1 according to an embodiment of the present disclosure is a processing system 1 including a cloud system 3 having the above configuration, a repeater 200 that establishes secret communication connection with the cloud system 3, and a control panel 300 communicably connected to the repeater 200. The control panel 300 generates third information for supporting and controlling the electric installation 400 and transmits the third information to the electric installation 400. With such a configuration, even in a situation where secret communication between the communication device 100 and the repeater 200 is impossible, the electric installation 400 can be urgently driven and operated, and continuous operation of the facility 2 is realized.

A repeater 200 according to an embodiment of the present disclosure is a repeater that establishes secret communication connection with the cloud system 3 having the above configuration, and includes a processor 312. The processor 312 is configured to execute processing for establishing the secret communication connection with the cloud system 3 installed in a different facility and receiving the second information in a secret state. With such a configuration, the operations of various electric installations 400 provided in the facility 2 can be controlled remotely, safely, and accurately.

A processing program according to an embodiment of the present disclosure causes a processor 112 and a processor 512 of a cloud system 3 to function as generating first information according to a type of an electric installation 400 installed in a different facility 2, processing the first information in accordance with a control panel 300 of the electric installation 400 to generate second information, establishing secret communication connection with at least one repeater 200 installed in the different facility 2, and transmitting the second information to the control panel 300 via the repeater 200 in a secret state. With such a configuration, the operations of various electric installations 400 provided in the facility 2 can be controlled remotely, safely, and accurately.

A processing method according to an embodiment of the present disclosure is a processing method executed by a processor 112 and a processor 512 of a cloud system 3 including the processor, the processing method including: a step of generating first information according to a type of an electric installation 400 installed in a different facility 2; a step of processing the first information in accordance with a control panel 300 of the electric installation 400 to generate second information; a step of establishing secret communication connection with at least one repeater 200 installed in the different facility 2; and a step of transmitting the second information to the control panel 300 via the repeater 200 in a secret state.

With such a configuration, the operations of various electric installations 400 provided in the facility 2 can be controlled remotely, safely, and accurately.

### 10. Modification

In the above embodiment, the Internet is used to establish the VPN connection which is the secret communication connection, but the secret communication connection may be performed using an actual dedicated communication line (real dedicated communication network) instead of such a virtual dedicated communication network. In such a case, the secret communication connection is enabled by a simple communication system without using a complicated communication protocol and encryption method for establishing the VPN connection.

In the above embodiment, the information supplied from the server device to the facility 2 via the communication device 100 is the control information and the request information, but the present disclosure is not limited thereto. For example, the information may be information regarding version upgrade of the control panel (update information) or information regarding maintenance or inspection of the control panel. By transmitting such information, it is possible to update the control panel without directly going to the facility 2, and it is possible to easily operate and manage the facility 2. Similarly, the information transmitted from the facility 2 to the cloud system 3 is the output information, but the present disclosure is not limited thereto. Specifically, various types of response information may be returned to the cloud system 3 based on request information transmitted from the cloud system 3 side.

Furthermore, in the above embodiment, the secret communication connection (VPN connection) is established from the communication device 100 to the repeater 200, but the secret communication connection may be established from the repeater 200 to the communication device 100 to transmit and receive each piece of information.

In the above embodiment, each configuration including the processor 112 of the communication device 100 and each configuration including the processor 512 of the server device 500 are separate, but the configurations may be integrated into one as each configuration of the cloud system 3.

The processing and the procedures described in the present specification can be realized not only by those explicitly described in the present disclosure but also by software, hardware, or a combination thereof. Specifically, the processing and the procedures described in the present specification are realized by implementing logic corresponding to the processing on a medium such as an integrated circuit, a volatile memory, a nonvolatile memory, a magnetic disk, or an optical storage. Furthermore, the processing and the procedures described in the present specification can be implemented as a computer program and executed by various computers including a terminal device and a server device.

Even if it is described that the processing and the procedures described in the present specification are executed by a single device, software, component, or module, such processing or procedures can be executed by a plurality of devices, a plurality of pieces of software, a plurality of components, and/or a plurality of modules. Furthermore, even if it is described that various types of information described in the present specification are stored in a single memory or storage unit, such information can be stored in a distributed manner in a plurality of memories provided in a single device or a plurality of memories arranged in a distributed manner in a plurality of devices. Furthermore, the software and hardware elements described in the present specification can be realized by integrating them into fewer components or decomposing them into more components.

1. A processing device comprising: at least one processor, wherein the at least one processor is configured to execute computer readable instructions so as to:
generate first information according to a type of an electric installation installed in a different facility,
processing the first information in accordance with a control panel of the electric installation to generate second information,
establish secret communication connection with at least one repeater installed in the different facility, and
transmit the second information to the control panel via the repeater in a secret state.

2. The processing device according to claim 1, wherein the secret communication connection is performed by a secret communication connection system using a virtual dedicated communication network.

3. The processing device according to claim 2, wherein the secret communication connection system is IPsec and IKEv2.

4. The processing device according to claim 2, wherein the secret communication connection includes encrypting the virtual dedicated communication network.

5. The processing device according to claim 4, wherein the encryption of the virtual dedicated communication network is performed by AES-GCM and ESP.

6. The processing device according to claim 1, wherein the secret communication connection is performed using a real dedicated communication network.

7. The processing device according to claim 1, wherein the at least one processor is configured to execute computer readable instructions so as to select an optimum path from one of a plurality of the secret communication connections established up to the repeater and transmits the second information.

8. A processing system comprising: the processing device according to claim 1; the repeater establishing the secret communication connection with the processing device; and the control panel communicably connected to the repeater, wherein
the control panel generates third information for supporting and controlling the electric installation, and transmits the third information to the electric installation.

9. A repeater that establishes secret communication connection with the processing device according to claim 1, the repeater comprising:
at least one processor, wherein
the at least one processor is configured to execute computer readable instructions so as to establish the secret communication connection with the processing device installed in the different facility and receiving the second information as secret information.

10. A computer program product embodying computer readable instructions stored on a non-transitory computer-readable storage medium for causing a computer to execute a process by at least one processor so as to perform the steps of:
generating first information according to a type of an electric installation installed in a different facility;
processing the first information in accordance with a control panel of the electric installation to generate second information;
establishing secret communication connection with at least one repeater installed in the different facility; and
transmitting the second information to the control panel via the repeater in a secret state.

11. A method for causing a processor to execute a process, the method comprising executing on a processor in a computer the steps of:
generating first information according to a type of an electric installation installed in a different facility;
processing the first information in accordance with a control panel of the electric installation to generate second information;
establishing secret communication connection with at least one repeater installed in the different facility; and
transmitting the second information to the control panel via the repeater in a secret state.
